(19) United States
(12) Patent Application Publication
(10) Pub. No.: US 2011/0024010 A1
(43) Pub. Date: Feb. 3, 2011

(54) PERFORMANCE ADAPTIVE TIRES UTILIZING ACTIVE MATERIAL ACTUATION

(75) Inventors: Alan L. Browne, Grosse Pointe, MI (US); Nancy L. Johnson, Northville, MI (US); Jan H. Aase, Oakland Township, MI (US)

Correspondence Address: SLJ, LLC, 324 E. 11th St., Ste. 101, Kansas City, MO, 64106, US

(73) Assignee: GM GLOBAL TECHNOLOGY OPERATIONS, INC., Detroit, MI (US)

(21) Appl. No.: 12/512,994

(22) Filed: Jul. 31, 2009

(51) Int. Cl. B60C 11/00

(52) U.S. Cl. 152/209.5

(57) ABSTRACT

An adaptive tire employable by a vehicle traveling upon a surface includes at least one active material element operable to selectively modify a structural component of the tire, and as a result a performance characteristic, such as the traction between the tire and surface, the ability for the tire to dampen standing waves, or the required mounting force, when activated.

### BACKGROUND OF THE INVENTION

1. Field of the Invention

The present disclosure generally relates to tires, such as automobile tires, and more particularly, to methods of enhancing tire performance utilizing active materials and to tires adapted to perform the same.

2. Discussion of Prior Art

Properly performing tires are important to ensure the health and safety of the user, as well as, to provide optimal fuel economy. Among the various factors contributing to performance, the traction, ride and handling, mount-ability, and the high speed/high load capabilities of the tire are particularly important. With respect to the latter, it is appreciated that the ability of the tire to minimize deleterious standing waves at high speeds, high loads, or low inflation pressures contribute to the longevity of the tire. It is widely appreciated in the art that these factors are influenced by ambient conditions. However, despite the varying nature of contributory factors, conventional tires typically present non-adaptive solutions.

### BRIEF SUMMARY

The instant invention presents an adaptive or “smart” tire that uses the advantages of active material actuation to modify a performance characteristic of the tire. As such, the invention is useful for maintaining proper performance over a wider range of conditions. In preferred embodiments, the invention is useful for tuning the structural components of the tire, to improve traction, reduce or dampen standing waves, and facilitate tire mounting and dismounting. As such, the invention is further useful for extending the life of the tire.

The adaptive tire is employable by a vehicle traveling upon a surface, adapted to selectively enhance a performance characteristic, and comprises at least one structural component. The component presents a first performance characteristic value. At least one active material element is inter-engaged with, and operable to modify the component(s), so as to modify the performance characteristic to a second value when activated. Variously presented the performance characteristic, so modified, includes the traction defined by the tire and surface, the ability of the tire to selectively reduce or dampen standing waves, and the force required to manipulate the bead when mounting and dismounting the tire.

The above described and other features are exemplified by the following figures and detailed description.

### BRIEF DESCRIPTION OF THE DRAWINGS

Preferred embodiments of the invention are described in detail below with reference to the attached drawing figures of exemplary scale, wherein:

FIG. 1 is an elevation of a vehicle traveling upon a surface and having a smart tire, in accordance with a preferred embodiment of the invention;

FIG. 2 is a perspective view of an adaptive tire, particularly illustrating a treadwall, a sidewall, and a hoop-shaped active material element composing the bead of the sidewall, in accordance with a preferred embodiment of the invention;

FIG. 2a is an outline view of the tire shown in FIG. 2, wherein the element presents a band traversing the sidewalls and treadwall, in accordance with a preferred embodiment of the invention;

FIG. 3 is a cross-sectional view of the various structural components of a smart tire having an inter-engaged active material hoop segment extending from bead to bead, in accordance with a preferred embodiment of the invention; and

FIG. 4 is a cross-sectional view of a smart tire having active material elements functionally disposed within tread elements, and further illustrating in enlarged caption view, the tread elements in a modified condition resulting from activation, in accordance with a preferred embodiment of the invention.

### DETAILED DESCRIPTION

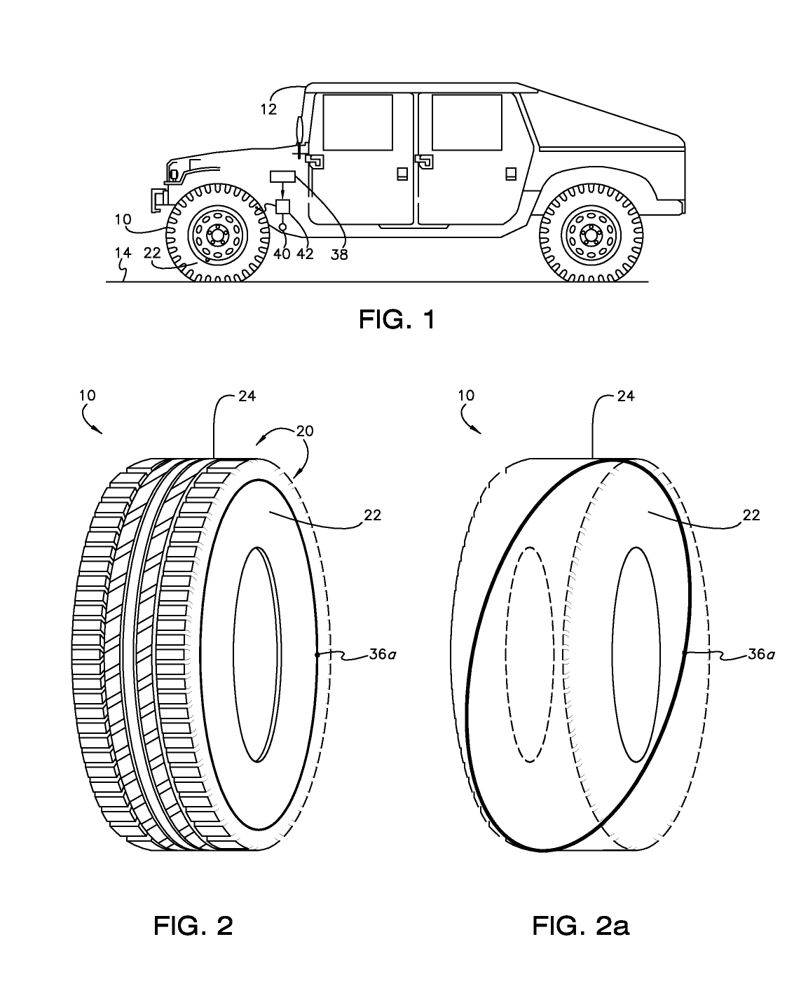

The present invention concerns plural methods of enhancing tire performance generally utilizing active materials, and smart tires 10 employing the same. In general, the inventive tires 10, described and illustrated herein employ active material actuation (and sensory capability to adapt to ambient and inherent conditions) to improve tire performance (FIGS. 1-4). The advantages and benefits of the invention may be used in various transportation applications (e.g., with respect to bicycles, aviation, etc.), but are more particularly suited for use with an automotive vehicle 12 (e.g., motorcycle, car, truck, SUV, all-terrain vehicle, etc.) traveling upon a surface 14. As such, the term “vehicle” as used herein shall encompass any device that would benefit from the autonomous and/or selective modifications further described herein, including bicycles.

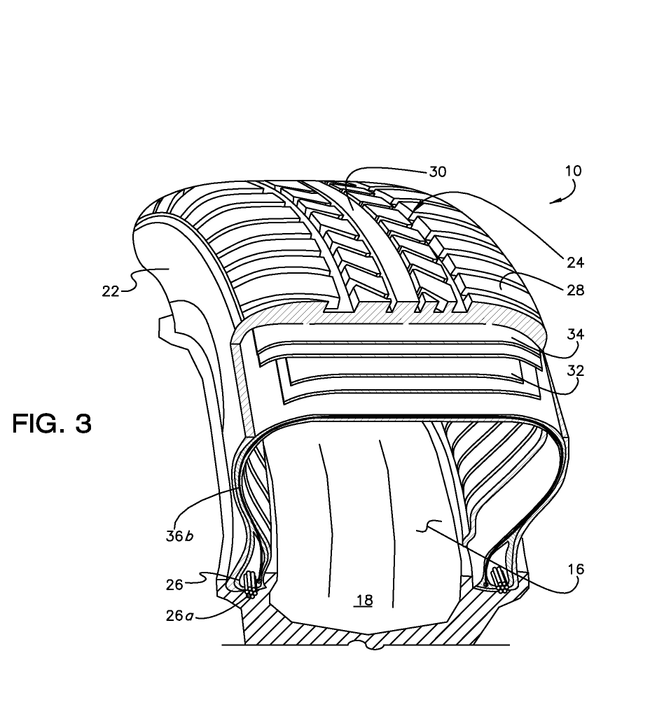

As best shown in FIGS. 2 and 3, the inventive modifications are adapted for use with an otherwise conventional elastomeric (e.g., synthetic and/or natural rubber) tire that defines an interior region 16 when mounted upon a wheel 18. A quantity of compressed air is retained within the region 16, so as to inflate the tire 10 to an operative state. The tire 10 is essentially formed by at least one structural component 20, including, in the illustrated embodiment, first and second opposite sidewalls 22 interconnected by a treadwall 24, wherein each sidewall 22 defines inner and outer peripheries, and a bead 26 running along the inner periphery. More particularly, and as shown in FIG. 3, the tire 10 may be of the type having a treadwall 24 consisting essentially of tread elements (or “blocks”) 28 and a central rib 30. The tread elements 28 define grooves 28a and sipes 28b that cooperatively form a tread pattern, stiffness, and depth.

The treadwall 24 presents chamfered or rounded lateral shoulders that transition into the outer periphery of the sidewalls 22. Underneath the tread elements 28, layers of reinforcing belts or plies 32 typically formed of steel or synthetic material, add structural stability and puncture resistance to the treadwall 24. Finally, cap plies 34 may be optionally provided intermediate the elements 28 and reinforcing belts 32 to secure the other components in place. The sidewalls 22 and treadwall 24 provide stability to the tire 10, and together with the compressed air, transfer the weight of the vehicle 12 and other operative forces to the surface 14. As shown in FIG. 1, it is appreciated that the tire 10 undergoes deformation as it rolls. It is also appreciated that the afore-described tire is described for exemplary purposes only, and that the present invention may be used with various tire configurations not described herein.

I. Active Material Discussion and Function

As previously mentioned, the inventive tire 10 employs the use of at least one active material element 36 to modify the applicable performance characteristics (FIGS. 2-4). The term “active material” shall be afforded its ordinary meaning as understood by those of ordinary skill in the art, and includes any material or composite that exhibits a reversible change in a fundamental (e.g., chemical or intrinsic physical) property, when exposed to an external signal source. Thus, active materials shall include those compositions that can exhibit a change in stiffness, modulus, shape and/or dimensions in response to the activation signal.

Depending on the particular active material, the activation signal can take the form of, without limitation, an electric current, an electric field (voltage), a temperature change, a magnetic field, a mechanical loading or stressing, and the like. For example, a magnetic field may be applied for changing the property of the active material fabricated from magnetostrictive materials. A heat signal may be applied for changing the property of thermally activated active materials such as SMA. An electrical signal may be applied for changing the property of the active material fabricated from electroactive materials, piezoelectrics, and/or ionic polymer metal composite materials. As such, it is appreciated that the tire 10 is communicatively coupled to a signal source 38 (e.g., the charging system of the vehicle 12) operable to generate a suitable activation signal (FIG. 1).

Suitable active materials for use with the present invention include, without limitation, shape memory alloys (SMA), shape memory polymers (SMP), electroactive polymers (EAP), piezoelectric materials (both unimorphic and bimorphic), such as piezoelectric polymers, magnetostrictive materials, electrostrictive materials, magnetorheological elastomers, electrorheological elastomers, and the like. The active material element 36 may take many geometric forms including pellets, beads, fillers, sheets, layers, and wires, wherein the term “wire” is further understood to encompass a range of longitudinal forms such as millimeter to several centimeter long strands, braids, strips, bands, cables, slabs, springs, etc.

More particularly, SMA generally refers to a group of metallic materials that demonstrate the ability to return to some previously defined shape or size when subjected to an appropriate thermal stimulus. Shape memory alloys are capable of undergoing phase transitions in which their yield strength, stiffness, dimension and/or shape are altered as a function of temperature. The term “yield strength” refers to the stress at which a material exhibits a specified deviation from proportionality of stress and strain. Generally, in the low temperature, or martensite phase, shape memory alloys can be plastically deformed and upon exposure to some higher temperature will transform to an austenite phase, or parent phase, returning to their shape prior to the deformation. Materials that exhibit this shape memory effect only upon heating are referred to as having one-way shape memory. Those materials that also exhibit shape memory upon re-cooling are referred to as having two-way shape memory behavior.

Shape memory alloys exist in several different temperature-dependent phases. The most commonly utilized of these phases are the so-called Martensite and Austenite phases discussed above. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (Aₛ). The temperature at which this phenomenon is complete is called the austenite finish temperature (A_{f}).

When the shape memory alloy is in the austenite phase and is cooled, it begins to change into the martensite phase, and the temperature at which this phenomenon starts is referred to as the martensite start temperature (Mₛ). The temperature at which austenite finishes transforming to martensite is called the martensite finish temperature (M_{f}). Generally, the shape memory alloys are softer and more easily deformable in their martensitic phase and are harder, stiffer, and/or more rigid in the austenitic phase. In view of the foregoing, a suitable activation signal for use with shape memory alloys is a thermal activation signal having a magnitude to cause transformations between the martensite and austenite phases.

Shape memory alloys can exhibit a one-way shape memory effect, an intrinsic two-way effect, or an extrinsic two-way shape memory effect depending on the alloy composition and processing history. Annealed shape memory alloys typically only exhibit the one-way shape memory effect. Sufficient heating subsequent to low-temperature deformation of the shape memory material will induce the martensite to austenite type transition, and the material will recover the original, annealed shape. Hence, one-way shape memory effects are only observed upon heating. Active materials comprising shape memory alloy compositions that exhibit one-way memory effects do not automatically reform, and will likely require an external mechanical force to reform the original shape.

Intrinsic and extrinsic two-way shape memory materials are characterized by a shape transition both upon heating from the martensite phase to the austenite phase, as well as an additional shape transition upon cooling from the austenite phase back to the martensite phase. Active materials that exhibit an intrinsic shape memory effect are fabricated from a shape memory alloy composition that will cause the active materials to automatically reform themselves as a result of the above noted phase transformations. Intrinsic two-way shape memory behavior must be induced in the shape memory material through processing. Such procedures include extreme deformation of the material while in the martensite phase, heating-cooling under constraint or load, or surface modification such as laser annealing, polishing, or shot-peening. Once the material has been trained to exhibit the two-way shape memory effect, the shape change between the low and high temperature states is generally reversible and persists through a high number of thermal cycles. In contrast, active materials that exhibit the extrinsic two-way shape memory effects are composite or multi-component materials that combine a shape memory alloy composition that exhibits a one-way effect with another element that provides a restoring force to reform the original shape.

The temperature at which the shape memory alloy remembers its high temperature form when heated can be adjusted by slight changes in the composition of the alloy and through heat treatment. In nickel-titanium shape memory alloys, for instance, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing the system with shape memory effects, superelastic effects, and high damping capacity.

Suitable shape memory alloy materials include, without limitation, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-platinum based alloys, iron-palladium based alloys, and the like. The alloys can be binary, ternary, or any higher order so long as the alloy composition exhibits a shape memory effect, e.g., change in shape orientation, damping capacity, and the like.

Thus, for the purposes of this invention, it is appreciated that SMA's exhibit a modulus increase of 2.5 times and a dimensional change of up to 8% (depending on the amount of pre-strain) when heated above their Martensite to Austenite phase transition temperature. It is appreciated that thermally induced SMA phase changes are one-way so that a biasing force return mechanism (such as a spring) would be required to return the SMA to its starting configuration once the applied field is removed. Joule heating can be used to make the entire system electronically controllable. Stress induced phase changes in SMA are, however, two way by nature. Application of sufficient stress when an SMA is in its Austenitic phase will cause it to change to its lower modulus Martensitic phase in which it can exhibit up to 8% of “superelastic” deformation. Removal of the applied stress will cause the SMA to switch back to its Austenitic phase in so doing recovering its starting shape and higher modulus.

Suitable piezoelectric materials include, but are not intended to be limited to, inorganic compounds, organic compounds, and metals. With regard to organic materials, all of the polymeric materials with non-centrosymmetric structure and large dipole moment group(s) on the main chain or on the side-chain, or on both chains within the molecules, can be used as suitable candidates for the piezoelectric film. Exemplary polymers include, for example, but are not limited to, poly(sodium 4-styrenesulfonate), poly(poly(vinylamine) backbone azo chromophore), and their derivatives; polyfluorocarbons, including polyvinylidenefluoride, its co-polymer vinylidene fluoride (“VDF”), co-trifluoroethylene, and their derivatives; polychlorocarbons, including poly(vinyl chloride), polyvinylidene chloride, and their derivatives; polyacrylonitriles, and their derivatives; polycarboxylic acids, including poly(methacrylic acid), and their derivatives; polyureas, and their derivatives; polyurethanes, and their derivatives; bio-molecules such as poly-L-lactic acids and their derivatives, and cell membrane proteins, as well as phosphate bio-molecules such as phosphodilipids; polyanilines and their derivatives, and all of the derivatives of tetramines; polyamides including aromatic polyamides and polyimides, including Kapton and polyetherimide, and their derivatives; all of the membrane polymers; poly(N-vinyl pyrrolidone) (PVP) homopolymer, and its derivatives, and random PVP-co-vinyl acetate copolymers; and all of the aromatic polymers with dipole moment groups in the main-chain or side-chains, or in both the main-chain and the side-chains, and mixtures thereof.

Piezoelectric materials can also comprise metals selected from the group consisting of lead, antimony, manganese, tantalum, zirconium, niobium, lanthanum, platinum, palladium, nickel, tungsten, aluminum, strontium, titanium, barium, calcium, chromium, silver, iron, silicon, copper, alloys comprising at least one of the foregoing metals, and oxides comprising at least one of the foregoing metals. Suitable metal oxides include SiO.sub.2, Al.sub.20.sub.3, ZrO.sub.2, TiO.sub.2, SrTiO.sub.3, PbTiO.sub.3, BaTiO.sub.3, FeO.sub.3, Fe.sub.30.sub.4, ZnO, and mixtures thereof and Group VIA and IIB compounds, such as CdSe, CdS, GaAs, AgCaSe.sub.2, ZnSe, GaP, InP, ZnS, and mixtures thereof. Preferably, the piezoelectric material is selected from the group consisting of polyvinylidene fluoride, lead zirconate titanate, and barium titanate, and mixtures thereof.

Electroactive polymers include those polymeric materials that exhibit piezoelectric, pyroelectric, or electrostrictive properties in response to electrical or mechanical fields. An example is an electrostrictive-grafted elastomer with a piezoelectric poly(vinylidene fluoride-trifluoro-ethylene) copolymer. This combination has the ability to produce a varied amount of ferroelectric-electrostrictive, molecular composite systems. These may be operated as a piezoelectric sensor or even an electrostrictive actuator.

Materials suitable for use as an electroactive polymer may include any substantially insulating polymer or rubber (or combination thereof) that deforms in response to an electrostatic force or whose deformation results in a change in electric field. Exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, polymers comprising silicone and acrylic moieties, and the like. Polymers comprising silicone and acrylic moieties may include copolymers comprising silicone and acrylic moieties, polymer blends comprising a silicone elastomer and an acrylic elastomer, for example.

Materials used as an electroactive polymer may be selected based on one or more material properties such as a high electrical breakdown strength, a low modulus of elasticity—(for large or small deformations), a high dielectric constant, and the like. In one embodiment, the polymer is selected such that it has an elastic modulus at most about 100 MPa. In another embodiment, the polymer is selected such that it has a maximum actuation pressure between about 0.05 MPa and about 10 MPa, and preferably between about 0.3 MPa and about 3 MPa. In another embodiment, the polymer is selected such that it has a dielectric constant between about 2 and about 20, and preferably between about 2.5 and about 12. The present disclosure is not intended to be limited to these ranges. Ideally, materials with a higher dielectric constant than the ranges given above would be desirable if the materials had both a high dielectric constant and a high dielectric strength. In many cases, electroactive polymers may be fabricated and implemented as thin films. Thicknesses suitable for these thin films may be below 50 micrometers.

As electroactive polymers may deflect at high strains, electrodes attached to the polymers should also deflect without compromising mechanical or electrical performance. Generally, electrodes suitable for use may be of any shape and material provided that they are able to supply a suitable voltage to, or receive a suitable voltage from, an electroactive polymer. The voltage may be either constant or varying over time. In one embodiment, the electrodes adhere to a surface of the polymer. Electrodes adhering to the polymer are preferably compliant and conform to the changing shape of the polymer. Correspondingly, the present disclosure may include compliant electrodes that conform to the shape of an electroactive polymer to which they are attached. The electrodes may be only applied to a portion of an electroactive polymer and define an active area according to their geometry. Various types of electrodes suitable for use with the present disclosure include structured electrodes comprising metal traces and charge distribution layers, textured electrodes comprising varying out of plane dimensions, conductive greases such as carbon greases or silver greases, colloidal suspensions, high aspect ratio conductive materials such as carbon fibrils and carbon nanotubes, and mixtures of ionically conductive materials.

Materials used for electrodes of the present disclosure may vary. Suitable materials used in an electrode may include graphite, carbon black, colloidal suspensions, thin metals including silver and gold, silver filled and carbon filled gels and polymers, and ionically or electronically conductive polymers. It is understood that certain electrode materials may work well with particular polymers and may not work as well for others. By way of example, carbon fibrils work well with acrylic elastomer polymers while not as well with silicone polymers.

Magnetostrictives are commonly termed active materials and yet the relative magnitude of the magnetostrictive effect ranges hugely over the various materials that are lumped in this class, for example “Terfinol” (R) exhibiting a giant magnetostrictive effect and Galfenol (Sp) exhibiting a “large” magnetostrictive effect. Suitable MR elastomer materials include, but are not intended to be limited to, an elastic polymer matrix comprising a suspension of ferromagnetic or paramagnetic particles, wherein the particles are described above. Suitable polymer matrices include, but are not limited to, poly-alpha-olefins, natural rubber, silicone, polybutadiene, polyethylene, polyisoprene, and the like.

Desirably, the change in the property of the active material remains for the duration of the applied activation signal. In one embodiment, upon discontinuation of the activation signal, the property of the active material generally reverts to an unpowered form and returns substantially to its original property. As used herein, the term “return mechanism” generally refers to any component capable of providing a force opposite to a force provided by the active material, and includes, without limitation, springs, elastomers, additional active materials, and the like.

Subdivisions and/or combinations of active material can provide additional desirable device benefits, such as improved package size, reduced weight, increased design scalability, larger angular displacements or torques, a digital or step-like actuation, a stacked or staggered actuation to improve controllable resolution, an active reset spring, or differential actuation via antagonistic wire configurations. Active material subdivisions may be configured electrically or mechanically in series or parallel and mechanically connected in telescoping, stacked, or staggered configurations. The electrical configuration may be modified during operation by software timing, circuitry timing, and external or actuation induced electrical contact.

II. Exemplary Smart Tire Configurations and Methods of Use

The present invention involves the use of shape memory alloys (SMA), or shape memory polymers (SMP) of sufficient stiffness, in a variety of geometric forms including but not limited to at least one wire to change the shape of the tire 10 either before and/or after reaching a steady state operating condition/temperature distribution. This is accomplished by embedding the active material element(s) 36 within the structural components of the tire 10. The elements 36 may present a standard circular cross-section or more preferably, a polygonal or “T”-shaped configuration for enhanced grabbing capability.

In a first aspect, the invention presents plural methods in which SMA is thermally activated to reduce or dampen standing waves that may form within the tire sidewall 22. Again, it is appreciated that standing waves occur at high loads and high speeds, but also at lower speeds when insufficient inflation pressure is combined with a localized thermal build-up in the sidewall 22. In this configuration, normally Martensitic SMA wires 36 are embedded such that localized strains in the SMA under normal driving conditions stay within the elastic range with no energy loss. When heated the increase in the stiffness of the sidewall 22 due to the transformation of SMA from its lower modulus Martensitic to its higher modulus Austenitic form will make it more resistant to the development of standing waves. More particularly, in one embodiment, the element 36 presents a hoop or band 36a running circumferentially (or at an angle with respect to) the longitudinal axis or rolling direction of the tire 10 (FIG. 2a).

To more efficiently reduce sidewall deformation (and its contribution to the formation of standing waves) the SMA bands 36 are placed as close to the tire exterior surface as possible. As the treadwall 24 heats during travel, the wires 36a are caused to stiffen (and contract if pre-strained). This reduces the tire deflection under load. As a final result, energy dissipation due to tire material moving into, through, and out of the contact patch is also reduced.

In a second example, a hoop segment 36b running from bead to bead, either directly around or at an angle with respect to the cross section (FIG. 3) may be used. The SMA wire hoop segment 36b extends into the treadwall 24, and is operable to increase the stiffness of the tire 10 at high speeds and/or temperatures conducive to standing wave formulation, as well as maintain the normal (i.e., smaller) rolling radius under normal operating conditions, where a larger patch may be desired. That is to say, when the running temperature increases, the SMA hoop segment 36b increases in stiffness, thereby reducing the vertical deflection of the sidewalls 22, and dampening the magnitude of any standing wave that may form therein. Once the active material is deactivated and allowed to cool, it is anticipated that the tire 10 will return to its original stiffness and shape, due in part to the spring-back of the elastomeric material.

In a second aspect of the invention, an SMA hoop 36a in super-elastic Austenitic phase is positioned adjacent the inner periphery of at least one sidewall 22, so as to compose the bead 26 (FIGS. 2 and 3). For example, the hoop 36a may present one or more of the wires of the bead wire bundle 26a. The hoop 36a is used to reduce the force necessary to mount the tire 10 onto the wheel 18, while maintaining an otherwise tight secure bead after mounting. To that end, the SMA wire 36a is selected such that normal operational forces are insufficient to cause stress induced activation, but average forces applied during manual or machine based mounting will cause transformation to the Martensitic state. In the Martensitic state, it is appreciated that the modulus of elasticity of the hoop 36a is decreased allowing an increase in the diameter of the hoop 36a for an applied mounting force. Once mounted and the force is released, the SMA hoop 36a will return to the more rigid Austenitic default state and a smaller dimension that effects a tighter seal.

Alternatively, the bead hoop 36a may be formed of SMA in Martensitic form (A_{f} of 80° C.), so as to allow the bead 26 to be more facilely stretched when mounting the tire 10 onto the wheel 18 without the need for activation. Here, it is appreciated that a pseudo-plastic stretch of 8% is recoverable. Once mounted, the SMA in the bead 26 can be heated (resistively or remotely) to trigger transformation to the Austenitic state and associated shape recovery and modulus increase. As a result, the tire 10 is further secured to the wheel 18. Higher temperatures during vehicle operation, especially at higher speeds and under higher loads will act to keep the bead bundle in its higher stiffness state.

In a third aspect of the invention, SMA elements 36b or other active material elements compose and/or extend into the treadwall 24, and are operable to selectively increase the traction of the tire 10, preferably in snow, rain, ice or otherwise normal operating conditions, wherein greater traction is desired. In one example, when the running temperature increases, discrete SMA segments 36b composing the tread material increase in stiffness, thereby reducing the magnitude of deformation experienced by the tire tread elements 28 and the associative traction. Once the active material is deactivated and allowed to cool, it is anticipated that the tread elements 28 will return to their original stiffness and shape, due in part to the spring-back of the elastomeric material.

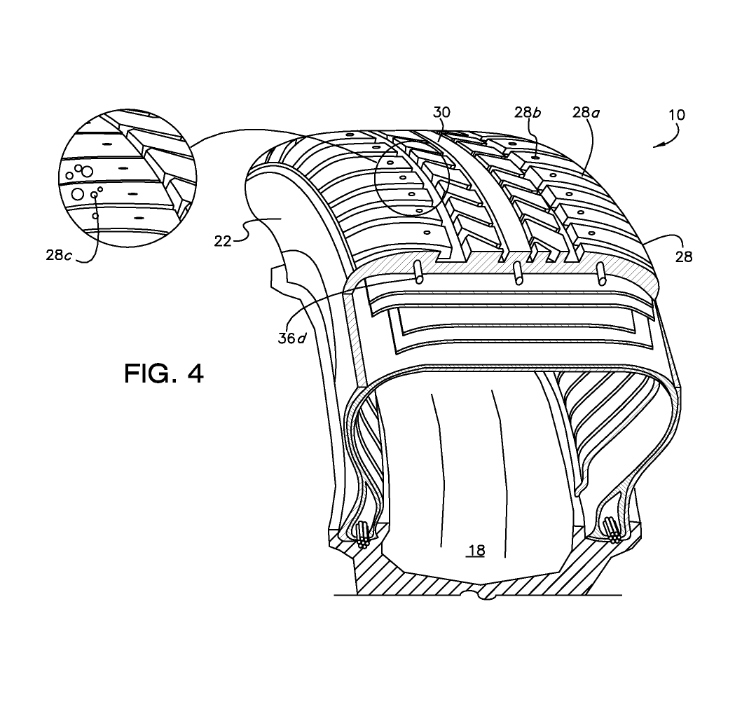

In another example, SMA elements 36 in the geometric form of wires, mesh, and/or segments thereof, are used to modify the surface texture/pattern of the tire 10 (FIG. 4). In this configuration, the elements 36 are preferably oriented parallel to and near the tread surface, and operable to produce on-demand (but also passively) surface texturing/wrinkling 28c through thermal activation. The on-demand wrinkling is used to produce significant enhancements in tire performance especially on smooth, wet, icy, and snow covered surfaces. In this configuration, while the preferred embodiment uses SMA for these functions, it is appreciated that embedded EAP's and piezopolymers may also be used to perform these functions.

Moreover, it is appreciated that considerable energy loss occurs during the deformation and flexing (e.g., “wiggle”) of tread elements 28. To reduce this energy loss, SMA segments 36d may again be used in the constituency of the tread 24. First, the segments 36d may be arranged so as to cause the tread elements 28 to compress in height when operating on dry pavement and thus reduce deflection, but then relax to full height when on cooler wet pavement to maximize traction Second, the segments 36d, when activated, may be arranged to close sipes 28b and other smaller openings that contribute to the flexibility of the tread 28, resulting in a more rigid tread 24 suitable for high speed operation. These openings would expand under cooling conditions when the SMA reverts to the Martensitic phase, such as during rain or when driving on snow, which would act to passively increase traction. Such motions of the tread elements 28 would also contribution to removal of debris and accumulated coatings from the tread pattern.

In operation, when the vehicle 12 reaches a certain predetermined speed or otherwise condition, wherein a specific performance characteristic is desirable, an activation signal can be generated to activate the active material element 36, so as to achieve the desired effect. For example, actuation of a vehicular turn signal may be configured to trigger the activation of tread elements 28, so as to reduce tire squeaking due to excessive traction during turning. When the vehicle condition stops (e.g., substantially reduces speed, completes the turn, etc.), the active material can be deactivated. The process may be repeated any number of desired times to improve fuel economy throughout the life of the vehicle, and as previously mentioned may be performed passively or on-demand. With respect to the latter, the vehicle 12 preferably includes at least one sensor 40 operable to detect the condition, and a controller 42 communicatively coupled to the sensor 40 and tire 10, and programmably configured to cause the element 36 to become activated when the condition is detected. As used herein, the terms “first”, “second”, and the like do not denote any order or importance, but rather are used to distinguish one element from another, and the terms “the”, “a”, and “an” do not denote a limitation of quantity, but rather denote the presence of at least one of the referenced item. Furthermore, all ranges directed to the same quantity of a given component or measurement is inclusive of the endpoints and independently combinable.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A tire employable by a vehicle traveling upon a surface, and adapted to selectively enhance a performance characteristic, said tire comprising:
a first structural component configured to engage the surface along a face, wherein the component presents a first performance characteristic value; and
at least one active material element inter-engaged with, and operable to modify the component, so as to modify the performance characteristic to a second value when activated.

2. The tire as claimed in claim 1, wherein the element is formed of an active material selected from the group consisting essentially of shape memory alloys, electroactive polymers, piezoelectrics, and magnetostrictives.

3. The tire as claimed in claim 1, wherein the active material element is formed of a shape memory alloy and presents a geometric shape selected from the group consisting essentially of wires, strips, sheets, meshes, weaves, braids, cables, hoops, and discrete segments thereof.

4. The tire as claimed in claim 1, further comprising:
a signal source operable to produce an activation signal sufficient to activate the element; and
an input device communicatively coupled to the source, and operable to receive an input and cause the element to be activated when the input is received.

5. The tire as claimed in claim 4, further comprising:
a controller communicatively coupled to the source, element, and device, and configured to cause the element to become activated when the input is received,
said device is a sensor, and the input is a detected condition.

6. The tire as claimed in claim 1, wherein the tire defines an interior periphery, the component is a bead defined along the periphery, and the bead includes the element, and presents a first radial stiffness when the element is activated and a second radial stiffness when the element is deactivated.

7. The tire as claimed in claim 6, wherein the element is formed of Austenitic shape memory alloy, and the first stiffness is less than the second.

8. The tire as claimed in claim 6, wherein the element is formed of Martensitic shape memory alloy, and the first stiffness is greater than the second.

9. The tire as claimed in claim 1, wherein the component includes first and second opposite sidewalls interconnected by a treadwall, the element is a shape memory material presenting a hoop segment extending within the sidewalls and treadwall, and configured to reduce standing waves in the component when activated.

10. The tire as claimed in claim 1, the element is made of shape memory material and presents a band operable to reduce standing waves in the component when activated.

11. The tire as claimed in claim 10, wherein the component is a sidewall presenting a first stiffness, and the element is operable to increase the stiffness when activated.

12. A method of passively reducing standing waves in a tire, said method comprising the steps of:
a. securing an active material element within at least a portion of the tire defining a first stiffness;
b. activating the element by exposure to a standing wave;
c. modifying said at least portion as a result of activating the element, so as to increase the stiffness;
d. reducing the wave as a result of increasing the stiffness; and
e. deactivating the element as a result of reducing the wave.

13. A tire employable by a vehicle traveling upon a surface, and adapted to selectively enhance traction, said tire comprising:
a first structural component configured to engage the surface along a face, so as to present a first traction value; and
at least one active material element inter-engaged with, and operable to modify the face, so as to modify the traction to a second value when activated.

14. The tire as claimed in claim 13, wherein the face presents a tread defining a pattern, tread stiffness, and depth, and the element is operable to modify the pattern, stiffness, and/or depth when activated.

15. The tire as claimed in claim 13, wherein the active material element presents a sub-surface layer underneath the face, and is operable to produce a texturing on the face and increase the traction when activated.

16. The tire as claimed in claim 13, wherein the face is defined by a plurality of tread elements presenting a first dimension, stiffness, and spacing, the active material element is operable to modify the dimension, stiffness, and/or spacing when activated.

17. The tire as claimed in claim 16, wherein the dimension is depth, and the active material element is operable to reduce the depth and increase the stiffness, when activated.

18. The tire as claimed in claim 16, wherein the dimension is width, and the active material element is operable to reduce the width, when activated.

19. The tire as claimed in claim 16, wherein the tread elements define sipes, grooves, and/or openings, and the active material element is operable to close the sipes, grooves, and/or openings when activated.
